(19) United States
(12) Patent Application Publication
(10) Pub. No.: US 2017/0116365 A1
(43) Pub. Date: Apr. 27, 2017

(54) INTEGRATED CIRCUIT USING STANDARD CELLS FROM TWO OR MORE LIBRARIES

(71) Applicant: FREESCALE SEMICONDUCTOR, INC., Austin, TX (US)

(72) Inventors: ZHIHONG CHENG, Suzhou (CN); Yifeng Liu, Chengdu (CN); Peidong Wang, Suzhou (CN)

(21) Appl. No.: 15/256,592

(22) Filed: Sep. 4, 2016

(30) Foreign Application Priority Data
Oct. 23, 2015 (CN) 201510976908.0

(51) Int. Cl. G06F 17/50

(52) U.S. Cl. CPC G06F 17/5072; G06F 17/505

(57) ABSTRACT

An integrated circuit (IC) has a block of instances of cells aligned in rows of at least first and second heights. The instances of cells are selected from at least two different libraries of standard cells that have heights that are integer multiples of the first and second heights respectively as a function of performance criteria of the instances of cells. The floorplan provides respective numbers of rows of the different heights as a function of the ratios of the total widths of rows of the different heights needed to place the selected standard cells.

### BACKGROUND

The present invention is directed to integrated circuits and, more particularly, to design of an integrated circuit using standard cells from two or more cell libraries.

Modern integrated circuits (ICs) are much too complex to be designed manually and are designed using electronic design automation (EDA) tools. An application specific IC (ASIC) or system on chip (SOC) may have tens or hundreds of millions of gates. Typically, design of an IC using EDA tools includes the steps of a design team using a logic synthesis tool to perform the process of mathematically transforming a high-level functional description in a hardware description language (HDL), called register-transfer level (RTL) design, into a technology-dependent netlist in a physical design stage.

In the physical design stage, synthesis is performed to map the RTL design into low-level logic cells such as AND, OR, INVERT, flip-flops, latches, and buffers. Standard cell libraries are used to implement the RTL design in a netlist. A standard cell library usually contains a variety of implementations of each logic function, differing in area, power, current and speed. This variety enhances the efficiency of commercially available EDA automated synthesis, and place and route (SPR) tools and gives greater freedom to perform implementation trade-offs (area against speed against power consumption). A technology library is a complete group of standard-cells and typically is developed and distributed by the fabrication plant (fab), often a foundry operator or a third-party design house or an IP vendor. The standard cells are full-custom layouts at transistor level, optimized for the technology level of the fab.

From an overall 2-D floorplan, a placement tool assigns detailed locations on the chip for each gate in the netlist. The resulting placed gates netlist contains the physical location of each of the standard cells of the netlists, with an abstract description of the wiring that connects the gates to each other.

Conventionally the standard cells of a given library have the same height as, or an integer multiple of the height of, the rows in which they are to be aligned on the 2-D surface of the IC. The ‘height’ of a cell or row refers to the vertical dimension seen in a floorplan view of the surface of the IC, corresponding to the pitch of the rows, whereas the ‘width’ refers to the dimension of a cell along a row, horizontally in the floorplan view. The different implementations of the standard cells for a given logic function are typically of different widths, and different area, power, current and speed. The chip will have a large number of rows (with power and ground lines running next to each row) and with each row filled with various standard cells.

Conventionally, the cells in the rows in the same sea of gates, or more specifically in the same block, are all taken from the same standard cell library, and all have the same height (measured by number of tracks) as the row height, or with an integer multiple of the row height. The characteristics of speed, power consumption, and area for certain cells are a compromise. For example, it is possible to implement fast cells in low height rows but the area utilized for those cells and their power consumption will be larger than if they are implemented in rows of greater height. It is also possible to implement slow cells in high height rows but again the area used for those cells and their power consumption will be larger than if they are implemented in rows of lower height. Thus, standard-cells of fixed height (counted by track number, e.g., N-track) from the same library used in the same sea of gates (SOG) design will not fit for a design that requires both high performance and low power consumption, although it can facilitate the place and route.

Using two or more sets of library of different height in the same SOG is not conventionally possible. Lower height cells (e.g., 5-track) are provided from a library for LOW speed/LOW power SOC while greater height cells (e.g., 13-track) are provided from a library for HIGH speed/HIGH power SOC, and MIDDLE cells (e.g., 9-track) are provided from a library for compromise between speed and power. While it is possible to implement high speed/high power cells in low height library and vice-versa, this will significantly degrade silicon utilization and increase the power consumption.

It would be advantageous to have an IC layout that offers a better adaptation of standard cells to the required power and speed characteristics, with better optimization of the semiconductor area utilization.

### BRIEF DESCRIPTION OF THE DRAWINGS

The present invention, together with objects and advantages thereof, may best be understood by reference to the following description of embodiments thereof shown in the accompanying drawings. Elements in the drawings are illustrated for simplicity and clarity and have not necessarily been drawn to scale.

FIGS. 1 and 2 are schematic floorplan views of conventional IC layouts;

FIG. 3 is a schematic floorplan view of an example of a layout of an IC in accordance with an embodiment of the present invention;

FIG. 4 is a flow chart of a method of physical design of an IC such as the IC of FIG. 3 in accordance with an embodiment of the present invention; and

FIG. 5 is a schematic block diagram of an EDA tool for performing the physical design method of the present invention, such as the method illustrated in FIG. 4.

### DETAILED DESCRIPTION

The present invention provides a method to allow the use of two or more sets of existing library cells of different heights in the same SOG without the need for trade-off between power and speed and at the same time provide higher silicon utilization. That is, the present invention is a method to use more than one set of standard-cell library cells in the same SOG, where the cells are designed to take advantage of the benefit but avoid the shortages of each library. For example, using a 5-track library together with a 9-track library, so both high speed and low power can be achieved as well as achieving high silicon utilization. In the method of the present invention, each standard library has cells with a predetermined height, so library “A” has height “x” and library “B” has a height “y”, where x<>y.

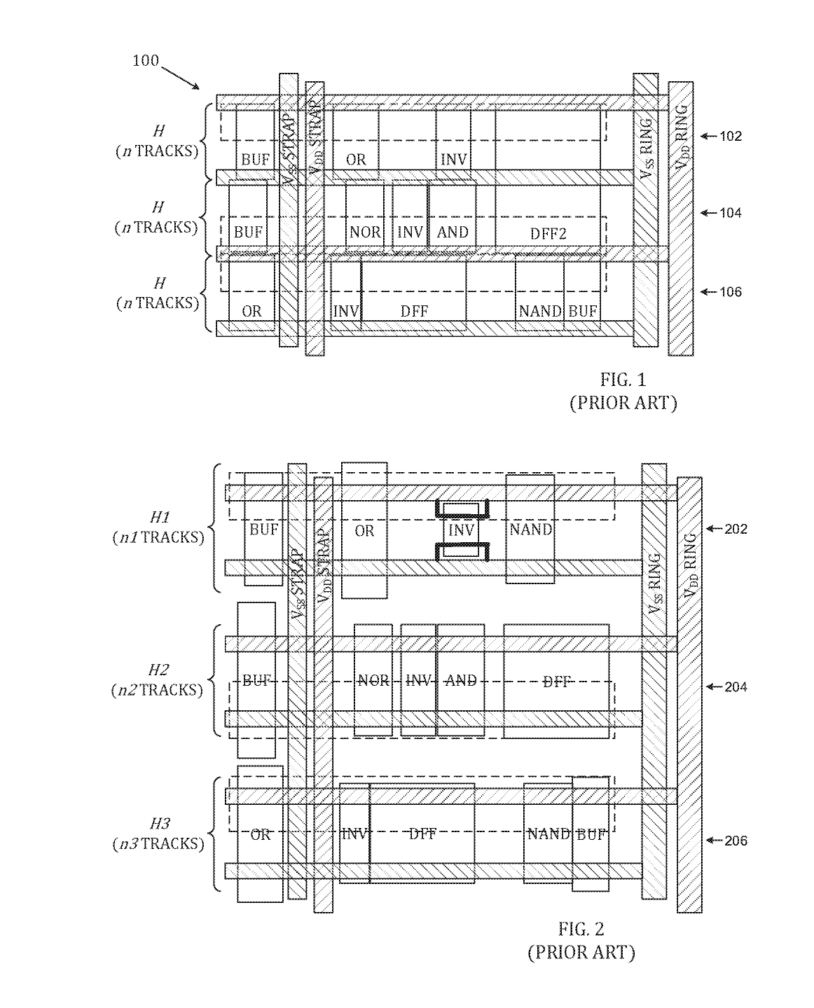

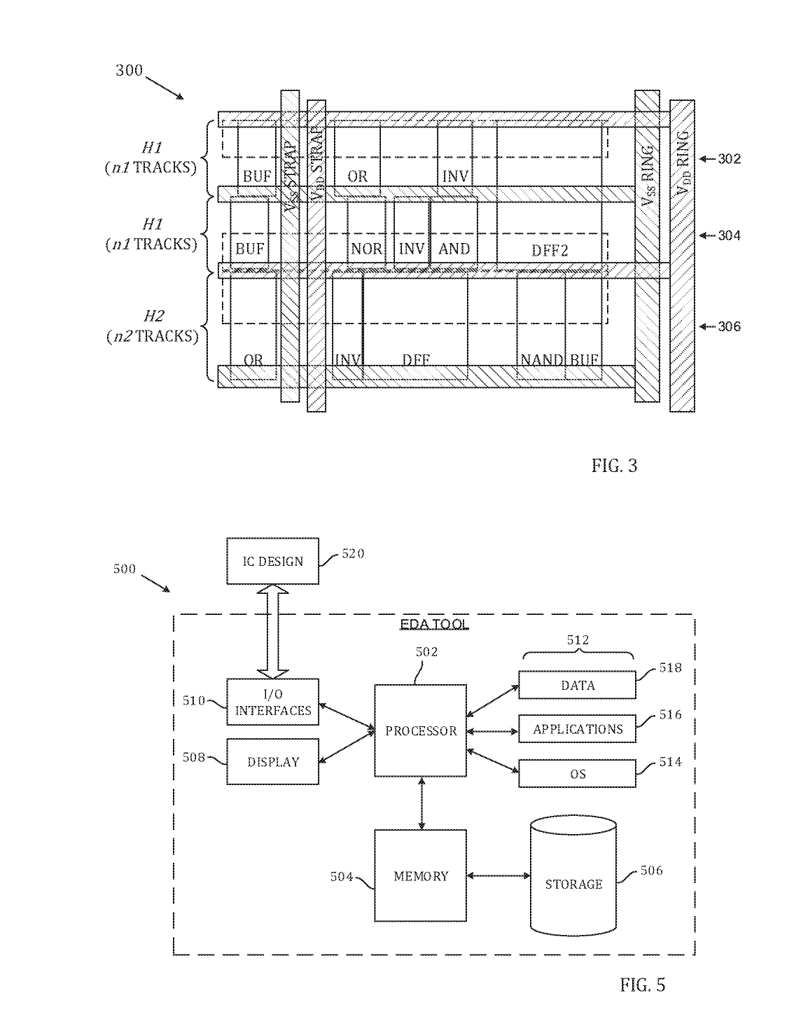

FIGS. 1 and 2 illustrate examples of conventional integrated circuits (ICs) 100 and 200. The ICs 100 and 200 are derived from a high-level functional description using a logic synthesis tool. The logic synthesis tool transforms the functional description of the RTL design into a technology-dependent netlist in the physical design stage. The RTL design is mapped into instances of logic cells such as AND, OR, INVERTER (INV), D-flip-flops (DFF), latches, and buffers (BUF), during synthesis. A standard cell library is used to implement the RTL design in a netlist containing a variety of implementations of each logic function, differing in area, power, current and speed.

In the IC 100, the cells in the rows in the same sea of gates (SOG), or more specifically in the same block, are all taken from a single standard cell library. The standard cells of the library all have the same height H or an integer multiple such as 2H (D-flip-flop DFF2) of the height H of, as the rows 102, 104, 106 in which they are aligned on the 2-D surface of the IC 100. The different implementations of the standard cells for a given logic function are typically of different widths, giving the choice of different area, power, current and speed. The heights of the cells and the rows are classified in numbers of tracks, such as 5-track, 9-track or 13-track, and it will be appreciated that a degree of approximation of the comparison of the cell and row physical heights is typical within this classification.

The choice of library for the SOG in the IC 100 will give the best compromise for some instances of the cells but not all instances. The compromise on the characteristics of speed, power consumption, and area for other cells will be sub-optimal, usually to the detriment of excess area and power consumption.

In the IC 200, the rows 202, 204, 206 of the SOG have heights H1, H2, H3, and some of the cells in the rows 202, 204, 206 have different height H from the height H1, H2, H3 of the rows 202, 204, 206. The routing of the power rails V_{DD} and V_{SS} are more complicated and they take more space. Some cells of different heights from the rows, for example INV in row 202, have to be designed as variants of standard cells in different libraries or be custom designs, which requires extra design effort. Unused area results from mixing greater height cells, for example BUF in rows 202 and 204 and OR in row 206, with the shorter cells in the same rows.

FIG. 3 illustrates a layout of an example of an IC 300 in accordance with the present invention. The IC 300 comprises a block of instances of cells such as AND, OR, INVERTER (INV), D-flip-flops (DFF), latches, and buffers (BUF) aligned in rows 302, 304, 306 of at least first and second heights H1, H2. The instances of cells are selected from at least first and second standard cell libraries that have heights that are integer multiples of the first and second heights H1, H2 respectively as a function of performance criteria of the instances of cells. The selected standard cells from the first and second libraries are aligned in the rows 302, 304, 306 of the first and second heights respectively. The selected standard cells in a row of the first or second height H1 or H2 are of height H1 or H2 (most of the cells) or of height 2H1 or 2H2 (D-flip-flop DFF2) or generally of height nH1 or nH2, respectively. Although three rows 302, 304, 306 of cells are shown in FIG. 3 for simplification, it will be appreciated that typically an IC 300 will have many more rows, for example several thousands.

The respective numbers N₁, N₂, . . . Nₙ, of rows 302, 304, 306 of the first and second heights H1, H2, . . . Hₙ, corresponds with the ratios ΣWIDTH1/ΣWIDTH2 . . . /ΣWIDTHn of the total widths needed to place the selected standard cells from the first and second (and nth) libraries respectively for the instances of cells in the block. The ratios ΣWIDTH1/ΣWIDTH2 . . . /ΣWIDTHn of the total widths will be rounded up to corresponding integer numbers of rows.

The IC 300 has less excess area usage than the ICs 100 and 200. The instances of cells can be all standard cells, from two or more libraries provided by the fab, for example. No design effort is necessary for variants of the standard cells or custom cell designs. The choice of libraries for the SOG in the IC 300 can give a better compromise on the characteristics of speed and power consumption and semiconductor area occupied than the ICs 100 or 200. In FIG. 3, the cells have different heights (H1, H2, . . . ) yet can be put in different rows of the same SOG, where the ratio of H1 to H2 can vary (e.g., 2:1). Each of the rows abuts an adjacent row (or two, one above and one below) to achieve high silicon efficiency.

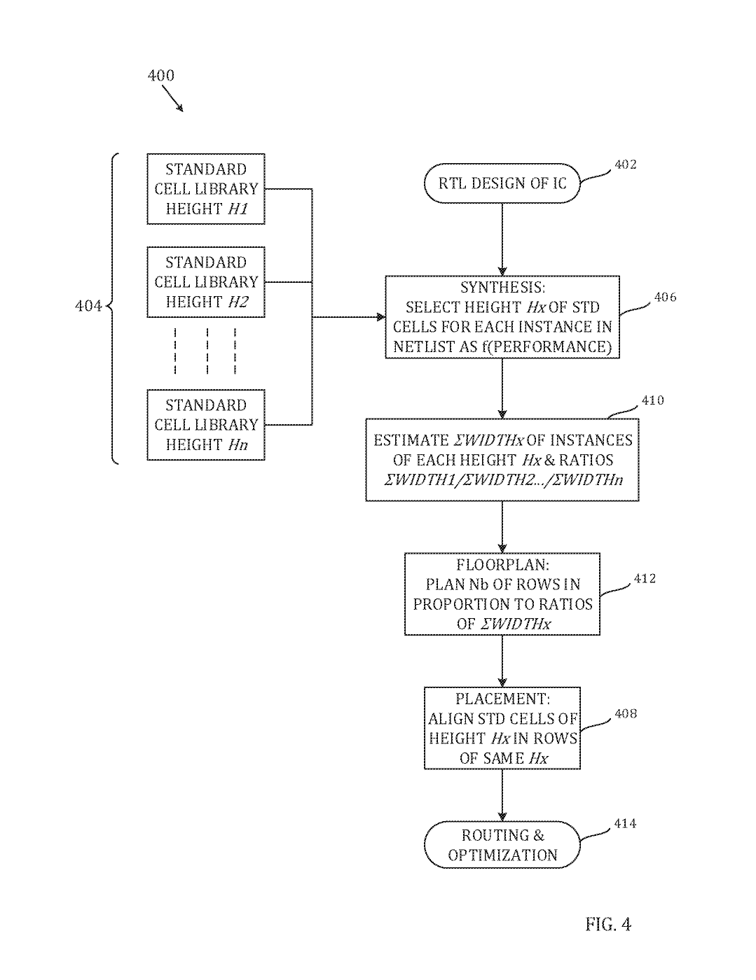

FIG. 4 is a flow chart of a method 400 in accordance with an embodiment of the invention for performing physical design of a block of an IC, such as the IC 300, using an EDA tool. FIG. 5 is a simplified block diagram of an EDA tool 500, which includes a processor 502 and memories 504, 506 coupled to the processor 502. The method 400 comprises providing in the memory 504, 506 an RTL design having hardware descriptions of instances of cells of the IC block at step 402. At step 404, the method 400 at least first and second libraries of standard cells that have heights that are integer multiples of first and second different heights H1 to Hn of rows 302, 304, 306 of cells respectively are provided. At step 406, a synthesis tool selects standard cells from the different libraries for the instances of cells in the RTL design as a function of performance criteria of the instances of cells. A placement tool aligns the selected standard cells from the first and second libraries in rows of the first and second heights respectively at step 408. Note, such synthesis and placement tools are well known in the art and commercially available.

The synthesis tool may estimate at step 410 the ratios ΣWIDTH1/ΣWIDTH2 . . . /ΣWIDTHn of the total widths of rows of the first height to the total widths of rows of the second height (and more generally nth height) needed to place the selected standard cells from the first and second (and nth) libraries respectively for the instances of cells in the block. At step 412, the method 400 provides in a floorplan respective numbers of rows of the first and second heights (and nth heights) as a function of the ratios. The placement step 408 may be followed at step 414 with routing, and optimization of timing, area and power consumption before testing and tape-out.

In FIG. 5, the EDA tool 500 also includes a display device 508, input/output interfaces 510, and software 512. The software 512 includes operating system software 514, applications programs 516, and data 518. The applications programs 516 can include, among other things, modules for use in architectural design, functional and logic design, circuit design, physical design, and verification. The data 518 can include an architectural design, a functional and logic design, a circuit design, a physical design, a modified or corrected physical design, and a library of standard cells and other components, with variants having different characteristics. The EDA tool 500 generally is known in the art except for the software used to implement the method of physical design of the IC. When software or a program is executing on the processor 502, the processor becomes a “means-for” performing the steps or instructions of the software or application code running on the processor 502. That is, for different instructions and different data associated with the instructions, the internal circuitry of the processor 502 takes on different states due to different register values, and so on, as is known by those of skill in the art. Thus, any means-for structures described herein relate to the processor 502 as it performs the steps of the methods disclosed herein.

The invention also includes a non-transitory computer-readable storage medium that stores instructions for executing on an EDA tool such as the EDA tool 500, which cause the EDA tool 500 to perform the physical design method 400.

The non-transitory computer-readable medium may contain a computer program for running on a computer system, the program at least including code portions for performing steps of a method according to the invention when run on a programmable apparatus, such as a computer system or enabling a programmable apparatus to perform functions of a device or system according to the invention.

The computer program may be stored internally on computer readable storage medium or transmitted to the computer system via a computer readable transmission medium. All or some of the computer program may be provided on non-transitory computer-readable media permanently, removably or remotely coupled to an information processing system. The computer-readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM and so on; and data transmission media including computer networks, point-to-point telecommunication equipment, and carrier wave transmission media, just to name a few.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

In the foregoing specification, the invention has been described with reference to specific examples of embodiments of the invention. It will, however, be evident that various modifications and changes may be made therein without departing from the broader spirit and scope of the invention as set forth in the appended claims.

For example, the semiconductor substrate described herein can be any semiconductor material or combinations of materials, such as gallium arsenide, silicon germanium, silicon-on-insulator (SOI), silicon, monocrystalline silicon, the like, and combinations of the above.

Moreover, the terms “front,” “back,” “top,” “bottom,” “over,” “under”, “height”, “width” and the like in the description and in the claims, if any, are used for descriptive purposes and not necessarily for describing permanent relative positions. It is understood that the embodiments of the invention described herein are, for example, capable of positioning and operation in other orientations than those illustrated or otherwise described herein.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In the claims, the word ‘comprising’ or ‘having’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An integrated circuit (IC) comprising a block of instances of cells aligned in rows of at least first and second heights;
wherein the instances of cells are selected from at least first and second libraries of standard cells that have heights that are integer multiples of the first and second heights respectively as a function of performance criteria of the instances of cells; and
wherein the selected standard cells from the first and second libraries are aligned in the rows of the first and second heights respectively.

2. The IC of claim 1, wherein the respective numbers of rows of the first and second heights corresponds with the ratios of the total widths needed to place the selected standard cells from the first and second libraries respectively for the instances of cells in the block.

3. A method of physical design of a block of an integrated circuit (IC) using an electronic design automation (EDA) tool wherein the EDA tool includes a processor and a memory coupled to the processor, the method comprising:
providing in the memory a register-transfer level (RTL) design having hardware descriptions of instances of cells of the IC block, and at least first and second libraries of standard cells that have heights that are integer multiples of first and second different heights of rows of cells respectively;
a synthesis tool selects standard cells from the different libraries for the instances of cells in the RTL design as a function of performance criteria of the instances of cells; and
a placement tool aligns the selected standard cells from the first and second libraries in rows of the first and second heights respectively.

4. The method of claim 3, wherein the synthesis tool estimates the ratios of the total widths of rows of the first height to the total widths of rows of the second height needed to place the selected standard cells from the first and second libraries respectively for the instances of cells in the block, and provides respective numbers of rows of the first and second heights as a function of the ratios.

5. A non-transitory computer-readable storage medium storing instructions for an electronic design automation (EDA) tool that includes a processor and a memory coupled to the processor, which when the instructions are executed cause the EDA tool to perform a method of physical design of a block of an integrated circuit (IC) from a register-transfer level (RTL) design having hardware descriptions of instances of cells of the IC block and from at least first and second libraries of standard cells that have heights that are integer multiples of first and second heights of rows of cells respectively, the RTL design and the libraries of standard cells being provided in the memory, the method comprising:
a synthesis tool selects standard cells from the different libraries for the instances of cells in the RTL design as a function of performance criteria of the instances of cells; and
a placement tool aligns the selected standard cells from the first and second libraries in rows of the first and second heights respectively.

6. The non-transitory computer-readable storage medium of claim 5, wherein the synthesis tool estimates the ratios of the total widths of rows of the first height to the total widths of rows of the second height needed to place the selected standard cells from the first and second libraries respectively for the instances of cells in the block, and provides respective numbers of rows of the first and second heights as a function of the ratios.
